(19) United States
(12) Patent Application Publication
(10) Pub. No.: US 2026/0322213 A1
(43) Pub. Date: Oct. 15, 2026

(54) E-Motor Stator Compact Cooling Spray Bar

(71) Applicant: Schaeffler Technologies AG & Co. KG, Herzogenaurach (DE)

(72) Inventors: Trevor McConnell, Wooster, OH (US); Clayton Habegger, Mansfield, OH (US)

(73) Assignee: Schaeffler Technologies AG & Co. KG, Herzogenaurach (DE)

(21) Appl. No.: 19/466,851

(22) Filed: Feb. 2, 2026

Related U.S. Application Data
(60) Provisional application No. 63/753,757, filed on Feb. 4, 2025.

(51) Int. Cl. H02K 9/14

(52) U.S. Cl. CPC H02K 9/14

(57) ABSTRACT

A cooling spray bar includes a base plate, a cover plate and a flow plate. The base plate includes a first annular portion with first spray holes and a first cylindrical portion with second spray holes. The cover plate includes a second annular portion contacting the first annular portion and a second cylindrical portion radially offset from the first cylindrical portion. The flow plate includes a third cylindrical portion with a circumferentially extending slot. In some example embodiments, the flow plate has a third annular portion with radial spray channels, the cover plate has a fourth annular portion, and the third annular portion is disposed axially between the first annular portion and the fourth annular portion. In some example embodiments, the fourth annular portion is disposed radially outside of the second annular portion. In an example embodiment, the first spray holes are aligned with the fourth annular portion.

### CROSS-REFERENCE TO RELATED APPLICATIONS

This application claims the benefit of U.S. Provisional Patent Application No. 63/753,757, filed Feb. 4, 2025, the disclosure of which is incorporated in its entirety by reference herein.

### TECHNICAL FIELD

The present disclosure relates generally to a spray bar, and more specifically to an e-motor stator cooling spray bar.

### BACKGROUND

Coolant spray assemblies for electric motors are known. One example is shown and described in U.S. Pat. No. 12,101,017 titled COOLANT FLUID SPRAYER ASSEMBLY FOR ELECTRIC MOTOR to McNaughton et al.

### SUMMARY

Example embodiments broadly comprise a cooling spray bar for an e-motor, including a base plate, a cover plate and an oil feed block. The base plate includes a first annular portion comprising a first plurality of spray holes, and an oil inlet. The cover plate includes a second annular portion contacting the first annular portion to form a chamber. The oil feed block includes a flow tube installed in the oil inlet and arranged to direct a cooling fluid to the chamber. In some example embodiments, the cooling spray bar also includes a baffle with a partial circumferential surface. In an example embodiment, the baffle is integrally formed with the cover plate from a same piece of material. In some example embodiments, the base plate also includes a first mounting tab with a first mounting hole, and the cover plate also includes a second mounting tab with a second mounting hole, aligned with the first mounting hole.

In some example embodiments, the cooling spray bar also includes a flow plate, the base plate also has a first cylindrical portion with a second plurality of spray holes, the cover plate also has a second cylindrical portion radially offset from the first cylindrical portion, and the flow plate has a third cylindrical portion with a circumferentially extending slot. In some example embodiments, the flow plate has a third annular portion with a radial spray channel, the cover plate has a fourth annular portion, and the third annular portion is disposed axially between the first annular portion and the fourth annular portion. In an example embodiment, the fourth annular portion is disposed radially outside of the second annular portion, the first plurality of spray holes are aligned with the fourth annular portion, and the second plurality of spray holes are distributed circumferentially and aligned with the circumferentially extending slot.

In an example embodiment, the first mounting tab extends from the first cylindrical portion, the second mounting tab extends from the second cylindrical portion, and the flow plate further includes a third mounting tab extending from the third cylindrical portion with a third mounting hole, aligned with the first mounting hole and the second mounting hole. In an example embodiment, the flow plate circumscribes the base plate, and the cover plate circumscribes the flow plate.

In an example embodiment, the oil inlet is rectangular shaped. In some example embodiments, the first annular portion also includes a pair of partial circumferential grooves hydraulically connecting respective quantities of the first plurality of spray holes, and a full circumferential groove hydraulically connecting the remaining quantity of the first plurality of spray holes. In some example embodiments, the pair of partial circumferential grooves are arranged at a same radius from a center of the first annular portion, and the full circumferential groove is arranged at a radius from the center of the first annular portion radially inside of the same radius. In some example embodiments, the first annular portion also includes a first pair of radially extending grooves, each hydraulically connecting a respective one of the pair of partial circumferential grooves to the oil inlet, and a second radially extending groove hydraulically connecting the full circumferential groove to the oil inlet. In an example embodiment, a width of the first pair of radially extending grooves is constant, and a width of the second radially extending groove decreases from the full circumferential groove to the oil inlet.

In an example embodiment, the base plate also includes a radial outer circumferential groove and a radial inner circumferential groove. The cover plate also includes a radial outer circumferential protrusion disposed in the radial outer circumferential groove, and a radial inner circumferential protrusion disposed in the radial inner circumferential groove. In some example embodiments the cooling spray bar also includes a back plate. The back plate includes a partial annular portion with a plurality of back spray holes, a back cover plate secured to the back plate to form a back chamber, and a back plate oil inlet. The oil feed block also includes a back tube installed in the back plate oil inlet and arranged to direct the cooling fluid to the back chamber. In an example embodiment, the back tube is aligned with the flow tube, and the oil feed block also includes a radial tube arranged to direct the cooling fluid to the flow tube and the back tube. In an example embodiment, the partial annular portion faces the first annular portion, at least a portion of the first plurality of spray holes are arranged to direct the cooling fluid towards the partial annular portion, and the plurality of back spray holes are arranged to direct the cooling fluid towards the first annular portion.

Other example embodiments broadly comprise an electric motor including a non-rotatable stator and the cooling spray bar at least partially radially overlapping and at least partially axially overlapping the non-rotatable stator. Other example embodiments broadly comprise a hybrid module including a housing with a flow channel, and the electric motor of claim 19. The non-rotatable stator and the cooling spray bar are fixedly secured to the housing, and the flow tube is hydraulically connected to the flow channel to provide the cooling fluid through the cooling spray bar to the non-rotatable stator.

### BRIEF DESCRIPTION OF THE DRAWINGS

FIG. 1 illustrates a cross-sectional view of a hybrid module, according to an example embodiment.

FIG. 2 illustrates a detail view of boxed portion 2 in FIG. 1.

FIG. 3 illustrates a perspective view of a cooling spray bar of the hybrid module of FIG. 1, according to an example embodiment.

FIG. 4 illustrates a partial cross-sectional view of the cooling spray bar of FIG. 3.

FIG. 5 illustrates an exploded view of the cooling spray bar of FIG. 3.

FIG. 6 illustrates a detail view of boxed portion 6 in FIG. 1.

FIG. 7 illustrates a perspective view of a cooling spray bar with a baffle, according to an example embodiment.

FIG. 8 illustrates a perspective view of cooling spray bar, according to an example embodiment.

FIG. 9 illustrates a perspective view of a cover plate of the cooling spray bar of FIG. 8.

FIG. 10 illustrates a perspective view of a base plate of the cooling spray bar of FIG. 8.

FIG. 11 illustrates a front view of the base plate of FIG. 10.

FIG. 12 illustrates a detail view of boxed portion 12 in FIG. 11.

FIG. 13 illustrates a partial cross-sectional view of the cooling spray bar of FIG. 8 taken generally along line 13-13 in FIG. 12.

FIG. 14 illustrates a partial cross-sectional view of the cooling spray bar of FIG. 8 taken generally along line 14-14 in FIG. 12.

FIG. 15 illustrates a top half cross sectional view of a hybrid module, according to an example embodiment.

FIG. 16 illustrates a front perspective view of a cooling spray bar of the hybrid module of FIG. 15, according to an example embodiment.

FIG. 17 illustrates a back perspective view of the cooling spray bar of FIG. 16.

FIG. 18 illustrates a bottom half cross-sectional view of the hybrid module of FIG. 15.

FIG. 19 illustrates a back perspective view of a portion of the cooling spray bar of FIG. 16.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

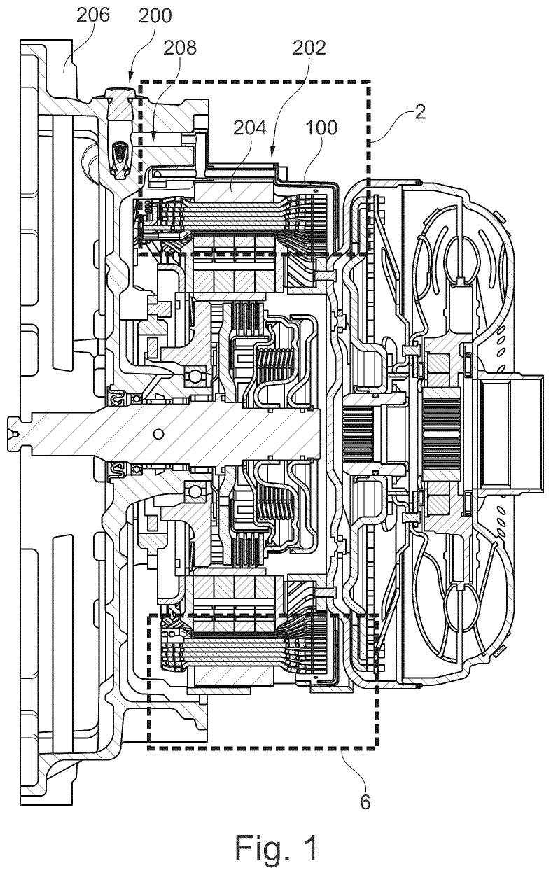

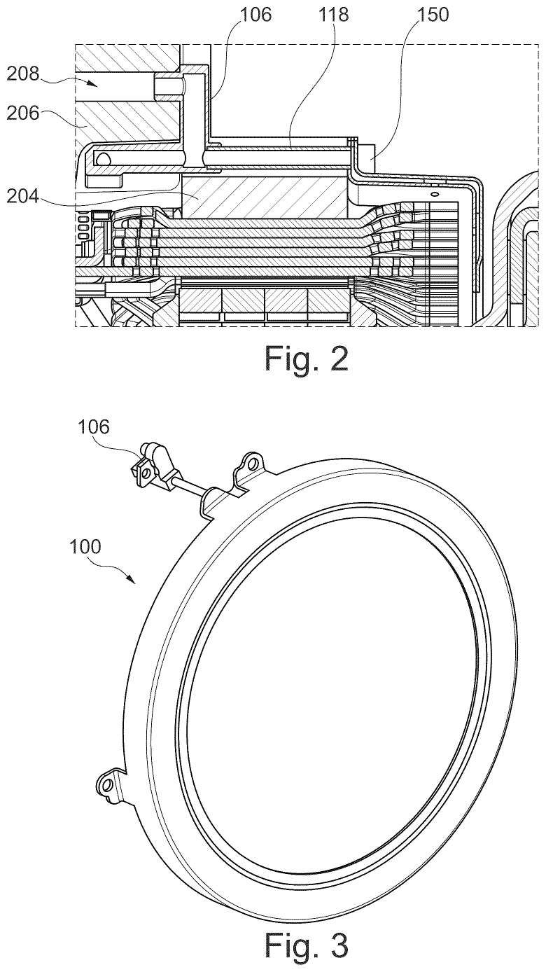

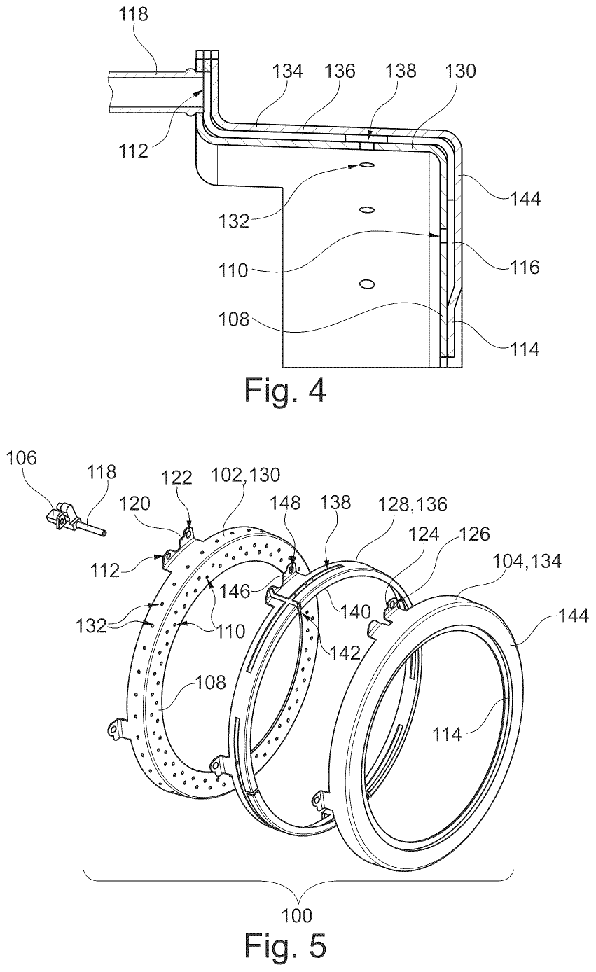

The following description is made with reference to FIGS. 1-5. FIG. 1 illustrates a cross-sectional view of hybrid module 200, according to an example embodiment. FIG. 2 illustrates a detail view of boxed portion 2 in FIG. 1. FIG. 3 illustrates a perspective view of cooling spray bar 100 of the hybrid module of FIG. 1, according to an example embodiment. FIG. 4 illustrates a partial cross-sectional view of the cooling spray bar of FIG. 3. FIG. 5 illustrates an exploded view of the cooling spray bar of FIG. 3.

Cooling spray bar 100 may be arranged to cool e-motor 202, for example. The cooling spray bar includes base plate 102, cover plate 104 and oil feed block 106. The base plate includes annular portion 108 with spray holes 110 and oil inlet 112. Spray holes 110 are arranged to direct a flow of cooling oil to cool e-motor 202, as described in more detail below. The cover plate includes annular portion 114, contacting annular portion 108, to form chamber 116. If the base plate and cover plate are metal, portions 108 and 114 may be welded or riveted together, for example, to at least partially seal the two surfaces together. If the base plate and cover plate are plastic, the two surfaces may be bonded or heat staked, for example. It should be noted that full sealing of the base plate and cover plate is not required as any oil that leaks through will still help to cool the system and will drain back to a sump to be redistributed. The oil feed block includes flow tube 118 installed in the oil inlet and arranged to direct cooling fluid to the chamber. The base plate and cover plate may be thin, sheet metal components, for example.

Base plate 102 also includes mounting tab 120 with mounting hole 122. Similarly, cover plate 104 also includes mounting tab 124 with mounting hole 126, aligned with mounting hole 122. Cooling spray bar 100 also includes flow plate 128. Base plate 102 also includes cylindrical portion 130 with spray holes 132, and cover plate 104 includes cylindrical portion 134, radially offset from cylindrical portion 130. Flow plate 128 includes cylindrical portion 136 with circumferentially extending slot 138, and annular portion 140 with radial spray channel 142. Cover plate 104 includes annular portion 144, and annular portion 140 is disposed axially between annular portions 108 and 144. Annular portion 144 is disposed radially outside of annular portion 114.

Annular portion 114 contacts annular portion 108 and annular portion 144 forms a portion of chamber 116 (ref. FIG. 4) such that a cooling flow received in the circumferentially extending slot travels through the radial spray channel into the chamber to be sprayed through spray holes 110 to cool stator 204 of the e-motor as discussed below. Spray holes 110 are aligned with annular portion 144. In other words, when viewed from an axial direction, spray holes 110 and annular portion 144 are overlapping. Similar to chamber 116 described above, spray holes 132 are distributed circumferentially and aligned with the circumferentially extending slot so that oil in the slot can be sprayed through holes 132. In this case, the slots and holes are aligned such that, when viewed in a radial direction, the slots and holes overlap.

Mounting tab 120 extends cylindrical portion 130, and mounting tab 124 extends from cylindrical portion 134. Flow plate 128 also includes mounting tab 146 extending from cylindrical portion 126 and having mounting hole 148, aligned with mounting holes 122 and 126. As shown in FIG. 2, for example, fastener 150 extends through the mounting holes to secure the cooling spray bar to housing 206 of the hybrid module.

As shown in FIG. 4, for example, the flow plate circumscribes the base plate and the cover plate circumscribes the flow plate. Otherwise stated, cylindrical portion 130 is radially inside of cylindrical portion 136, and cylindrical portion 136 is radially inside of cylindrical portion 134. Flow tube 118 is arranged to direct a cooling fluid to the circumferentially extending slot.

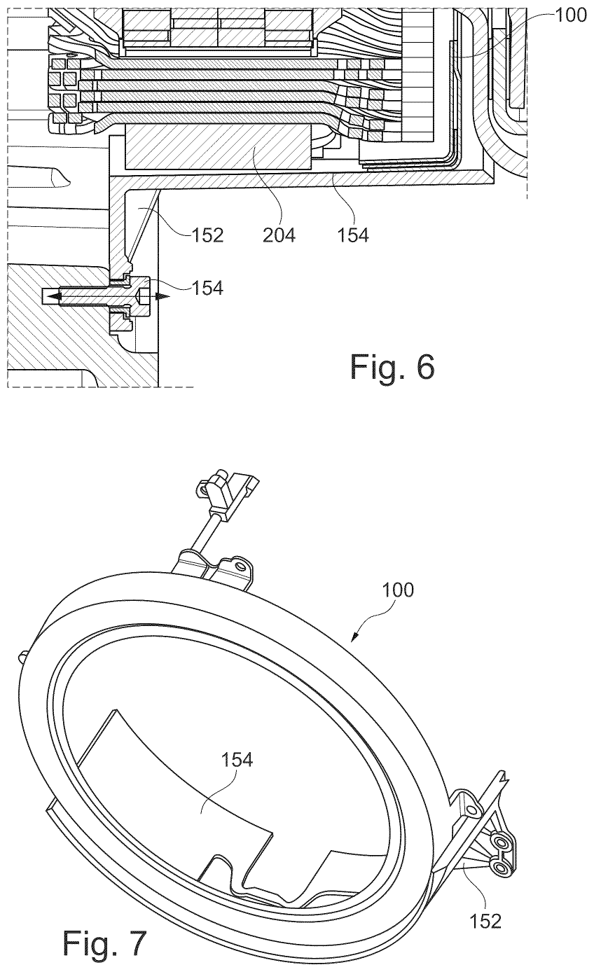

The following description is made with reference to FIGS. 1-7. FIG. 6 illustrates a detail view of boxed portion 6 in FIG. 1. FIG. 7 illustrates a perspective view of cooling spray bar 100 with baffle 152, according to an example embodiment. Cooling spray bar 100 also includes baffle 152 including partial circumferential surface 154. When installed in hybrid module 200, the baffle redirects cooling fluid around the stator to a sump to be recirculated. The baffle may be a stamped steel part or a molded plastic part, for example. As shown in FIG. 7, for example, the baffle may be integrally formed with the cover from a same piece of material. Baffle 152 is secured to the housing by fastener 150. It should be noted that the baffle is an optional part of spray bar 100 and the spray bar will still function without the baffle.

Returning to FIG. 1, electric motor, or e-motor, 202 includes non-rotatable stator 204 and cooling spray bar 100 at least partially radially overlaps and at least partially axially overlaps the non-rotatable stator. By radially overlapping, we mean that the spray bar at least partially overlaps the stator when viewed in a radial direction. Similarly, by axially overlapping, we mean that the spray bar at least partially overlaps the stator when viewed in an axial direction. Steel components of the cooling spray bar may be treated (e.g., coated) with a non-conductive coating to permit installation within close proximity of the stator.

Hybrid module 200 includes housing 206 and electric motor 202. Non-rotatable stator 204 and cooling spray bar 100 are fixedly secured to the housing. Housing 206 includes flow channel 208 and oil feed block 106 includes flow tube 118 hydraulically connected to the flow channel to provide a cooling fluid through the cooling spray bar to the non-rotatable stator. That is, cooling flow from the flow channel extends through the flow tube to be distributed by the spray holes to cool the stator as described above. As discussed above, cooling spray bar 100 also includes baffle 152 secured to the housing via fasteners 150. Baffle 152 includes partial circumferential surface 154 arranged to redirect fluid as discussed above.

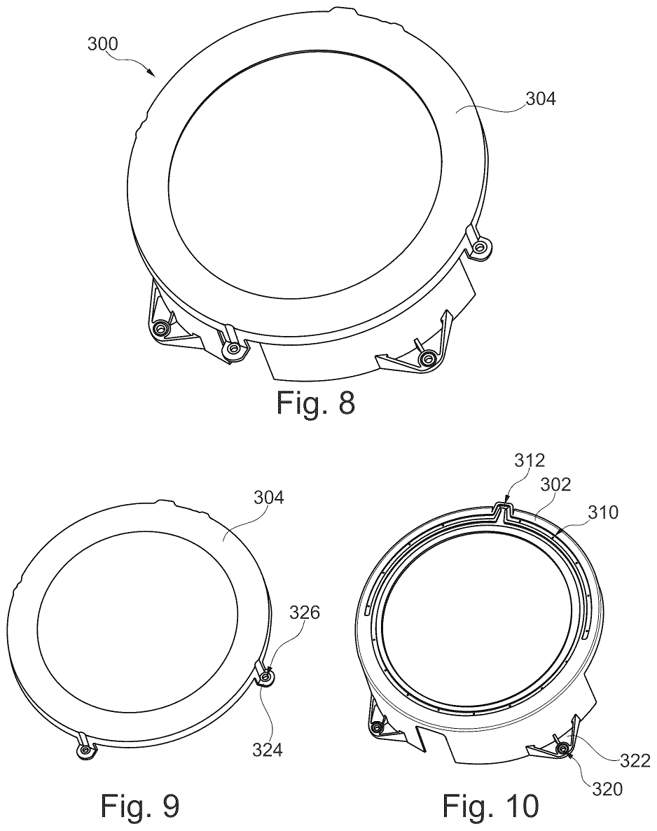

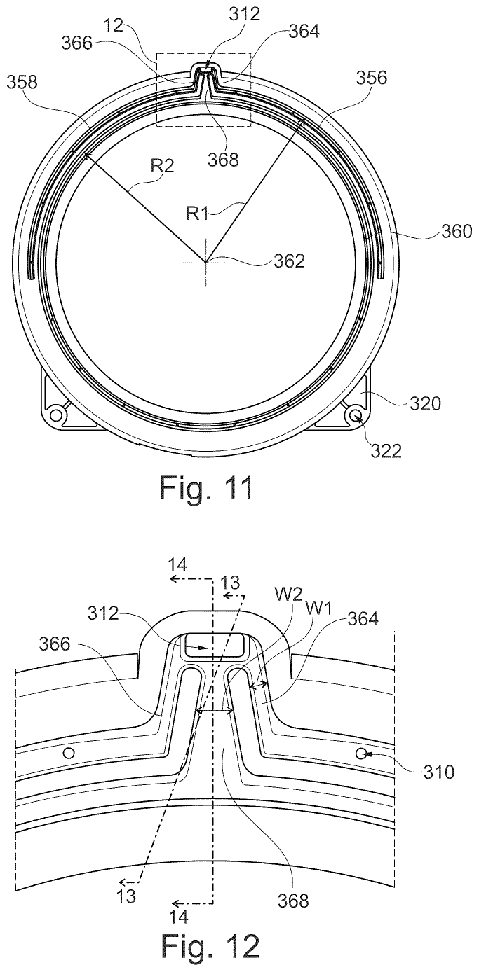

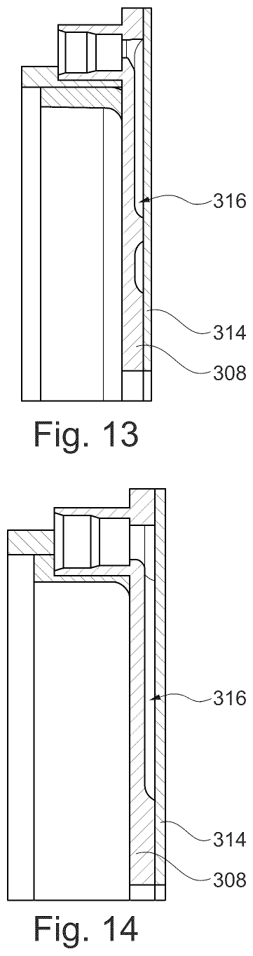

The following description is made with reference to FIGS. 8-14. FIG. 8 illustrates a perspective view of cooling spray bar 300, according to an example embodiment. FIG. 9 illustrates a perspective view of cover plate 304 of the cooling spray bar of FIG. 8. FIG. 10 illustrates a perspective view of base plate 302 of the cooling spray bar of FIG. 8. FIG. 11 illustrates a front view of the base plate of FIG. 10. FIG. 12 illustrates a detail view of boxed portion 12 in FIG. 11. FIG. 13 illustrates a partial cross-sectional view of the cooling spray bar of FIG. 8 taken generally along line 13-13 in FIG. 12. FIG. 14 illustrates a partial cross-sectional view of the cooling spray bar of FIG. 8 taken generally along line 14-14 in FIG. 12.

Cooling spray bar 300 may be arranged to cool an e-motor, similar to cooling spray bar 100 described above, for example. The cooling spray bar includes base plate 302, cover plate 304 and oil feed block (not shown). The base plate includes annular portion 308 with spray holes 310 and oil inlet 312. Spray holes 310 are arranged to direct a flow of cooling oil to cool an e-motor, as described above. The cover plate includes annular portion 314, contacting annular portion 308, to form chamber 316. If the base plate and cover plate are metal, portions 308 and 314 may be welded or riveted together, for example, to at least partially seal the two surfaces together. If the base plate and cover plate are plastic, the two surfaces may be bonded or heat staked, for example. It should be noted that full sealing of the base plate and cover plate is not required as any oil that leaks through will still help to cool the system and will drain back to a sump to be redistributed. The base plate and cover plate may be thin, sheet metal components, for example.

Base plate 302 also includes mounting tab 320 with mounting hole 322. Similarly, cover plate 304 also includes mounting tab 324 with mounting hole 326. As shown in FIG. 12, for example, oil inlet 312 is rectangular shaped. Annular portion 308 also includes partial circumferential grooves 356 and 358 hydraulically connecting respective quantities of spray holes 310, and full circumferential groove 360 hydraulically connecting the remaining quantity of spray holes 310. Partial circumferential grooves 356 and 358 are arranged at a same radius R1 from center 362 of annular portion 308, and full circumferential groove 360 is arranged at a radius R2 from the center radially inside of the same radius R1.

Annular portion 308 also includes radially extending grooves 364 and 366, each hydraulically connecting a respective one of the partial circumferential grooves to the oil inlet, and radially extending groove 368 hydraulically connecting the full circumferential groove to the oil inlet. Width W1 of radially extending grooves 364 and 366 is constant, and width W2 of radially extending groove 368 decreases from the full circumferential groove to the oil inlet.

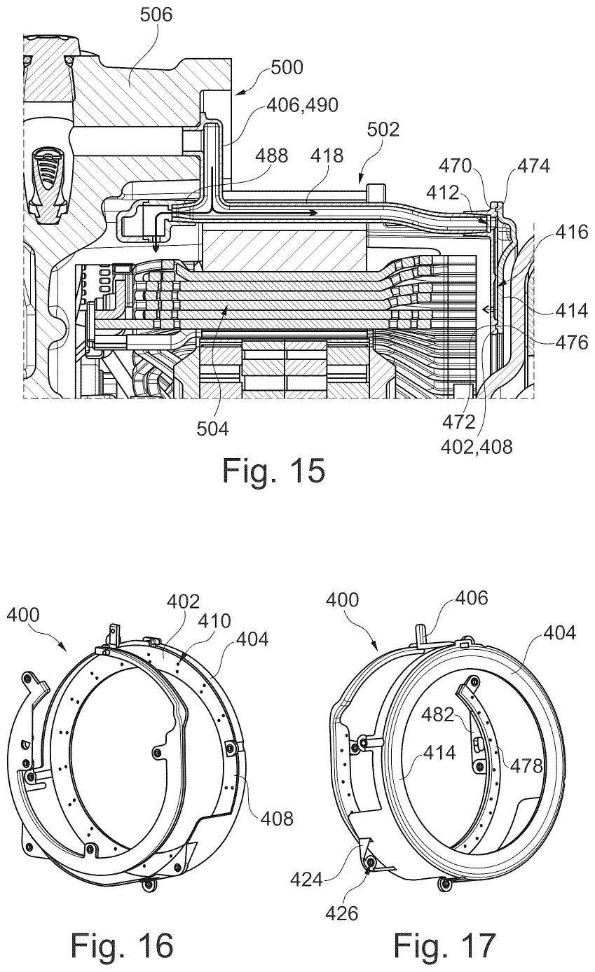

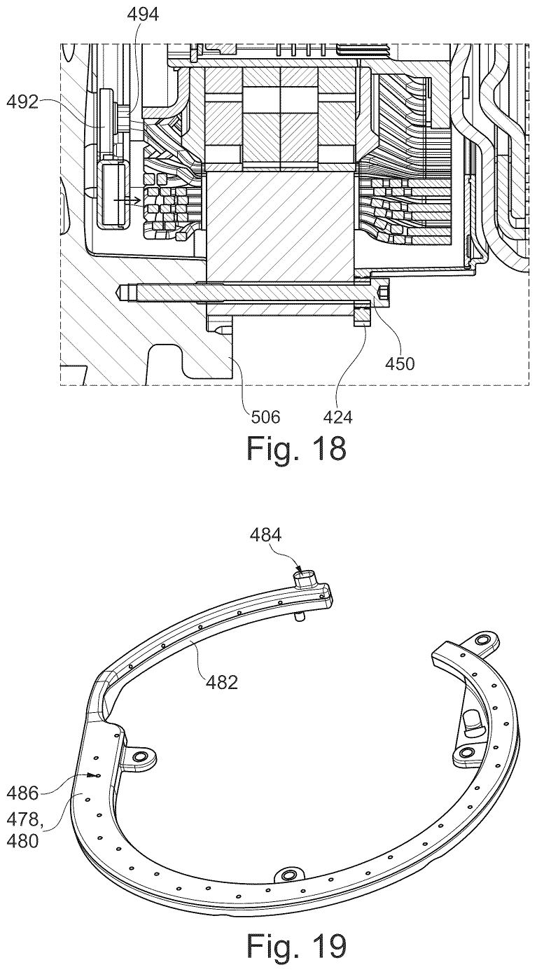

The following description is made with reference to FIGS. 15-19. FIG. 15 illustrates a top half cross sectional view of hybrid module 500, according to an example embodiment. FIG. 16 illustrates a front perspective view of cooling spray bar 400 of the hybrid module of FIG. 15, according to an example embodiment. FIG. 17 illustrates a back perspective view of the cooling spray bar of FIG. 16. FIG. 18 illustrates a bottom half cross-sectional view of the hybrid module of FIG. 15. FIG. 19 illustrates a back perspective view of a portion of the cooling spray bar of FIG. 16.

Cooling spray bar 400 may be arranged to cool e-motor 502, for example. The cooling spray bar includes base plate 402, cover plate 404 and oil feed block 406. The base plate includes annular portion 408 with spray holes 410 and oil inlet 412. Spray holes 410 are arranged to direct a flow of cooling oil to cool e-motor 502, as described in more detail below. The cover plate includes annular portion 414, contacting annular portion 408, to form chamber 416. If the base plate and cover plate are metal, portions 408 and 414 may be welded or riveted together, for example, to at least partially seal the two surfaces together. If the base plate and cover plate are plastic, the two surfaces may be bonded or heat staked, for example. It should be noted that full sealing of the base plate and cover plate is not required as any oil that leaks through will still help to cool the system and will drain back to a sump to be redistributed. The oil feed block includes flow tube 418 installed in the oil inlet and arranged to direct cooling fluid to the chamber. The base plate and cover plate may be thin, sheet metal components, for example.

Cover plate 404 includes mounting tab 424 with mounting hole 426. Base plate 402 also includes radial outer circumferential groove 470 and radial inner circumferential groove 472. Cover plate 404 also includes radial outer circumferential protrusion 474 disposed in the radial outer circumferential groove, and radial inner circumferential protrusion 476 disposed in the radial inner circumferential groove. Cooling spray bar 400 also includes back plate 478 including partial annular portion 480, back cover plate 482 secured to the back plate to form a back chamber, and back plate oil inlet 484. Mounting tab 424 is secured to housing 506 via fastener 450, and back cover plate mounting tab 492 is secured to the housing via fastener 494.

The partial annular portion includes back spray holes 486 and the oil feed block also includes back tube 488 installed in the back plate oil inlet and arranged to direct the cooling fluid to the back chamber. The back tube is aligned with the flow tube, and the oil feed block also includes radial tube 490 arranged to direct the cooling fluid to the flow tube and the back tube. Partial annular portion 480 faces annular portion 408. At least some of spray holes 410 are arranged to direct the cooling fluid towards the partial annular portion, and back spray holes 486 are arranged to direct the cooling fluid towards annular portion 408.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100 Cooling spray bar
102 Base plate
104 Cover plate
106 Oil feed block
108 Annular portion (base plate, first)
110 Spray holes (first)
112 Oil inlet
114 Annular portion (cover plate, second)
116 Chamber
118 Flow tube
120 Mounting tab (base plate, first)
122 Mounting hole (first mounting tab, first)
124 Mounting tab (cover plate, second)
126 Mounting hole (second mounting tab, second)
128 Flow plate
130 Cylindrical portion (base plate, first)
132 Spray holes (second)
134 Cylindrical portion (cover plate, second)
136 Cylindrical portion (flow plate, third)
138 Circumferentially extending slot
140 Annular portion (flow plate, third)
142 Radial spray channel
144 Annular portion (cover plate, fourth)
146 Mounting tab (flow plate, third)
148 Mounting hole (third mounting tab, third)
150 Fastener
152 Baffle
154 Partial circumferential surface (baffle)
200 Hybrid module
202 E-motor
204 Stator (e-motor)
206 Housing
208 Flow channel (housing)
300 Cooling spray bar
302 Base plate
304 Cover plate
308 Annular portion (base plate, first)
310 Spray holes (first)
312 Oil inlet
314 Annular portion (cover plate, second)
316 Chamber
320 Mounting tab (base plate, first)
322 Mounting hole (first mounting tab, first)
324 Mounting tab (cover plate, second)
326 Mounting hole (second mounting tab, second)
356 Partial circumferential groove
358 Partial circumferential groove
360 Full circumferential groove
362 Center (first annular portion)
364 Radially extending groove (first)
366 Radially extending groove (first)
368 Radially extending groove (second)
400 Cooling spray bar
402 Base plate
404 Cover plate
406 Oil feed block
408 Annular portion (base plate, first)
410 Spray holes (first)
412 Oil inlet
414 Annular portion (cover plate, second)
416 Chamber
418 Flow tube
424 Mounting tab (cover plate, second)
426 Mounting hole (second mounting tab, second)
450 Fastener
470 Radial outer circumferential groove
472 Radial inner circumferential groove
474 Radial outer circumferential protrusion
476 Radial inner circumferential protrusion
478 Back plate
480 Partial annular portion (back plate)
482 Back cover plate
484 Back plate oil inlet
486 Back spray holes
488 Back tube
490 Radial tube (oil feed block)
492 Back cover plate mounting tab
494 Fastener
500 Hybrid module
502 E-motor
504 Stator
506 Housing
R1 Same radius
R2 Radius
W1 Width (first)
W2 Width (second)

What is claimed is:

1. A cooling spray bar for an e-motor, comprising:
a base plate, comprising:
a first annular portion comprising a first plurality of spray holes; and
an oil inlet;
a cover plate, comprising:
a second annular portion contacting the first annular portion to form a chamber; and
an oil feed block comprising a flow tube installed in the oil inlet and arranged to direct a cooling fluid to the chamber.

2. The cooling spray bar of claim 1, further comprising a baffle, the baffle comprising a partial circumferential surface.

3. The cooling spray bar of claim 2, wherein the baffle is integrally formed with the cover plate from a same piece of material.

4. The cooling spray bar of claim 1, wherein:
the base plate further comprises a first mounting tab comprising a first mounting hole; and
the cover plate further comprises a second mounting tab comprising a second mounting hole, aligned with the first mounting hole.

5. The cooling spray bar of claim 4 further comprising a flow plate, wherein:
the base plate further comprises a first cylindrical portion comprising a second plurality of spray holes;
the cover plate further comprises a second cylindrical portion radially offset from the first cylindrical portion; and
the flow plate comprises a third cylindrical portion comprising a circumferentially extending slot.

6. The cooling spray bar of claim 5, wherein:
the flow plate comprises a third annular portion comprising a radial spray channel;
the cover plate comprises a fourth annular portion; and
the third annular portion is disposed axially between the first annular portion and the fourth annular portion.

7. The cooling spray bar of claim 6, wherein:
the fourth annular portion is disposed radially outside of the second annular portion;
the first plurality of spray holes are aligned with the fourth annular portion; and
the second plurality of spray holes are distributed circumferentially and aligned with the circumferentially extending slot.

8. The cooling spray bar of claim 5, wherein:
the first mounting tab extends from the first cylindrical portion;
the second mounting tab extends from the second cylindrical portion; and
the flow plate further comprises a third mounting tab extending from the third cylindrical portion and comprising a third mounting hole, aligned with the first mounting hole and the second mounting hole.

9. The cooling spray bar of claim 5, wherein:
the flow plate circumscribes the base plate; and
the cover plate circumscribes the flow plate.

10. The cooling spray bar of claim 1, wherein the oil inlet is rectangular shaped.

11. The cooling spray bar of claim 1, wherein the first annular portion further comprises:
a pair of partial circumferential grooves hydraulically connecting respective quantities of the first plurality of spray holes; and
a full circumferential groove hydraulically connecting the remaining quantity of the first plurality of spray holes.

12. The cooling spray bar of claim 11, wherein:
the pair of partial circumferential grooves are arranged at a same radius from a center of the first annular portion; and
the full circumferential groove is arranged at a radius from the center of the first annular portion radially inside of the same radius.

13. The cooling spray bar of claim 12, wherein the first annular portion further comprises:
a first pair of radially extending grooves, each hydraulically connecting a respective one of the pair of partial circumferential grooves to the oil inlet; and
a second radially extending groove hydraulically connecting the full circumferential groove to the oil inlet.

14. The cooling spray bar of claim 13, wherein:
a width of the first pair of radially extending grooves is constant; and
a width of the second radially extending groove decreases from the full circumferential groove to the oil inlet.

15. The cooling spray bar of claim 1, wherein:
the base plate further comprises:
a radial outer circumferential groove; and
a radial inner circumferential groove; and
the cover plate further comprises:
a radial outer circumferential protrusion disposed in the radial outer circumferential groove; and
a radial inner circumferential protrusion disposed in the radial inner circumferential groove.

16. The cooling spray bar of claim 1, further comprising:
a back plate, comprising:
a partial annular portion comprising a plurality of back spray holes;
a back cover plate secured to the back plate to form a back chamber; and
a back plate oil inlet, wherein the oil feed block further comprises a back tube installed in the back plate oil inlet and arranged to direct the cooling fluid to the back chamber.

17. The cooling spray bar of claim 16 wherein the back tube is aligned with the flow tube, the oil feed block further comprising a radial tube arranged to direct the cooling fluid to the flow tube and the back tube.

18. The cooling spray bar of claim 16, wherein:
the partial annular portion faces the first annular portion;
at least a portion of the first plurality of spray holes are arranged to direct the cooling fluid towards the partial annular portion; and
the plurality of back spray holes are arranged to direct the cooling fluid towards the first annular portion.

19. An electric motor, comprising:
a non-rotatable stator; and
the cooling spray bar of claim 1 at least partially radially overlapping and at least partially axially overlapping the non-rotatable stator.

20. A hybrid module, comprising:
a housing comprising a flow channel; and
the electric motor of claim 19, wherein:
the non-rotatable stator and the cooling spray bar are fixedly secured to the housing; and
the flow tube is hydraulically connected to the flow channel to provide the cooling fluid through the cooling spray bar to the non-rotatable stator.
